(19) United States
(12) Patent Application Publication
(10) Pub. No.: US 2025/0187708 A1
(43) Pub. Date: Jun. 12, 2025

(54) METHOD FOR GENERATING TOPOLOGICAL GRAPH OF VESSEL SYSTEM AND RELATED DEVICE

(71) Applicant: GUANGDONG EPROPULSION TECHNOLOGY LIMITED, Dongguan (CN)

(72) Inventors: Guanfu CHEN, Dongguan (CN); Yuefeng LIU, Dongguan (CN); Shizheng TAO, Dongguan (CN); Xiaokang WAN, Dongguan (CN)

(73) Assignee: GUANGDONG EPROPULSION TECHNOLOGY LIMITED, Dongguan (CN)

(21) Appl. No.: 19/057,920

(22) Filed: Feb. 19, 2025

Related U.S. Application Data
(63) Continuation of application No. PCT/CN2022/117642, filed on Sep. 7, 2022.

(51) Int. Cl. B63B 49/00; B63B 79/40; G07C 5/08

(52) U.S. Cl. CPC B63B 49/00; B63B 79/40; G07C 5/0816

(57) ABSTRACT

A method and an apparatus for generating a topological graph of a vessel system, an outboard engine, a vessel and a storage medium are provided. A plurality of access devices of the vessel system are configured to communicate through a communication bus of the vessel system, and the method includes: obtaining device identification information sent by each of the access devices through the communication bus; determining description information of a topological structure of the vessel system according to the device identification information, the description information being used to characterize a connection relationship between each of the access devices and the communication bus; and sending the description information to a display device so that the display device converts the description information into a topological graph and displays the topological graph.

### CROSS-REFERENCE TO RELATED APPLICATION

This application is a continuation of International Application No. PCT/CN2022/117642, filed on Sep. 7, 2022. The entire contents of the above-referenced application are expressly incorporated herein by reference.

### TECHNICAL FIELD

The application relates to the technical field of a topological graph of a vessel system, in particular to a method and a device for generating the topological graph of the vessel system, an outboard engine, a vessel and a storage medium.

### TECHNICAL BACKGROUND

The topological graph of the vessel system can show the user what access devices are included in the vessel system and the connection relationship between the access devices. However, the topological graph of the vessel system usually needs to be manually generated by the user according to the composition of the vessel system, and the efficiency of generating the topological graph is low.

### SUMMARY

In order to overcome the problems existing in the related art, the present application provides a method and a device for generating a topological graph of a vessel system, an outboard engine, a vessel, and a storage medium.

According to the first aspect of some embodiments of the present application, a method for generating a topological graph of a vessel system is provided, wherein a plurality of access devices of the vessel system communicate through a communication bus of the vessel system. The method includes: obtaining device identification information sent by each of the access devices through the communication bus; determining description information of a topological structure of the vessel system according to the device identification information, the description information being used to characterize a connection relationship between each of the access devices and the communication bus; sending the description information to a display device so that the display device converts the description information into a topological graph and displays the topological graph.

According to a second aspect of some embodiments of the present application, a device for generating a topological graph of a vessel system is provided, wherein a plurality of access devices of the vessel system communicate through a communication bus of the vessel system. The device includes: a first obtaining module configured to obtain device identification information sent by each of the access devices through the communication bus; a first determining module configured to determine description information of a topological structure of the vessel system according to the device identification information, the description information being used to characterize a connection relationship between each of the access devices and the communication bus; a first sending module configured to send the description information to a display device so that the display device converts the description information into a topological graph and displays the topological graph.

According to a third aspect of some embodiments of the present application, an outboard engine is provided. The outboard engine includes: a propeller; a motor configured to drive the propeller to rotate; a processor connected to the motor, the processor being configured to execute the method for generating a topological graph of a vessel system according to any one of the embodiments of the present application.

According to a fourth aspect of some embodiments of the present application, a vessel is provided. The vessel includes: a hull; the outboard engine according to any one of the embodiments of the present application, the outboard engine being mounted to the hull.

According to a fifth aspect of some embodiments of the present application, a computer-readable storage medium is provided. A computer program is stored on the computer-readable storage medium, and the computer program is executed by a processor to implement the method for generating a topological graph of a vessel system according to any one of the embodiments of the present application.

The technical solution provided by the embodiments of the present application may include the following beneficial effects.

In the embodiments of the present application, the device identification information sent by each of the access devices through the communication bus is obtained, and the description information of the topological structure of the vessel system is generated according to the obtained device identification information. The description information can not only describe what access devices are in the vessel system, but also describe the connection relationship between each of the access devices and the communication bus. Sending the description information to the display device, the display equipment can convert the description information into the topological graph and display the topological graph, so that the topological graph of the vessel system can be generated directly and automatically, the efficiency of generating the topological graph is improved, and the intelligent level of the vessel can be improved.

It should be understood that both the above general description and the following detailed description are only exemplary and explanatory and are not restrictive of the application.

### BRIEF DESCRIPTION OF DRAWINGS

The accompanying drawings herein, which are incorporated into the specification and constitute a part of the specification, illustrate embodiments in accordance with the present application and serve to explain the principles of the present application with the specification.

FIG. 1 is a flow chart of a method for generating a topological graph of a vessel system illustrated according to an exemplary embodiment of the present application.

FIG. 2 is a flow chart of another method for generating the topological graph of the vessel system illustrated according to an exemplary embodiment of the present application.

FIG. 3 is a schematic diagram of a connection relationship between the plurality of outboard engines and the plurality of batteries illustrated according to an exemplary embodiment of the present application.

FIG. 4 is a flow chart of another method for generating the topological graph of the vessel system illustrated according to an exemplary embodiment of the present application.

FIG. 5 is a schematic diagram of the relative positions of three outboard engines illustrated according to an exemplary embodiment of the present application.

FIG. 6 is another schematic diagram of the relative position of three outboard engines illustrated according to an exemplary embodiment of the present application.

FIG. 7 is a flow chart of another method for generating the topological graph of the vessel system illustrated according to an exemplary embodiment of the present application.

FIG. 8 is a flow chart of another method for generating the topological graph of the vessel system illustrated according to an exemplary embodiment of the present application.

FIG. 9 is a flow chart of another method for generating the topological graph of the vessel system illustrated according to an exemplary embodiment of the present application.

FIG. 10 is a flow chart of another method for generating the topological graph of the vessel system illustrated according to an exemplary embodiment of the present application.

FIG. 11 is a flow chart of another method for generating the topological graph of the vessel system illustrated according to an exemplary embodiment of the present application.

FIG. 12 is a topological graph of a vessel system in the related art.

FIG. 13 is a topological graph of the vessel system illustrated according to an exemplary embodiment of the present application.

FIG. 14 is a flow chart of another method for generating the topological graph of the vessel system illustrated according to an exemplary embodiment of the present application.

FIG. 15 is another topological graph of the vessel system illustrated according to an exemplary embodiment of the present application.

FIG. 16 is a flow chart of another method for generating the topological graph of the vessel system illustrated according to an exemplary embodiment of the present application.

FIG. 17 is a flow chart of another method for generating the topological graph of the vessel system illustrated according to an exemplary embodiment of the present application.

FIG. 18 is a schematic diagram of a apparatus for generating the topological graph of the vessel system illustrated according to an exemplary embodiment of the present application.

FIG. 19 is another schematic diagram of the apparatus for generating the topological graph of the vessel system illustrated according to an exemplary embodiment of the present application.

FIG. 20 is another schematic diagram of the apparatus for generating the topological graph of the vessel system illustrated according to an exemplary embodiment of the present application.

FIG. 21 is another schematic diagram of the apparatus for generating the topological graph of the vessel system illustrated according to an exemplary embodiment of the present application.

FIG. 22 is another schematic diagram of the apparatus for generating the topological graph of the vessel system illustrated according to an exemplary embodiment of the present application.

FIG. 23 is a schematic diagram of an outboard engine illustrated according to an exemplary embodiment of the present application.

FIG. 24 is a schematic diagram of a vessel illustrated according to an exemplary embodiment of the present application.

### DETAILED DESCRIPTION

The technical solutions in the embodiments of the present application will be described below with reference to the drawings in the embodiments of the present application. Obviously, the described embodiments are only a part of the embodiments of the present application, not all of the embodiments. Based on the embodiments in the present application, all other embodiments obtained by those of ordinary skill in the art without creative work fall within the scope of protection of the present application. In addition, in the absence of conflict, the embodiments and features of the embodiments described below may be combined with each other.

Exemplary embodiments will be described herein in detail, examples of which are illustrated in the accompanying drawings. When the following description refers to the drawings, the same numbers in different drawings indicate the same or similar elements, unless otherwise indicated. The embodiments described in the following exemplary embodiments are not intended to represent all embodiments consistent with the present application. Rather, they are merely examples of apparatus and methods consistent with some aspects of the application as detailed in the appended claims.

The terminology used herein is for the purpose of describing particular embodiments only and is not intended to limit the application. As used in this application and the appended claims, the singular forms “a,” “an,” “said,” and “the” are intended to include the plural forms as well, unless the context clearly dictates otherwise. It should also be understood that the term “and/or” as used herein refers to and encompasses any or all possible combinations of one or more of the associated listed items.

It should be understood that, although the terms first, second, third, etc. may be used herein to describe various information, the information should not be limited to these terms. These terms are used only to distinguish the type of information from one another. For example, without departing from the scope of the present application, the first information may also be referred to as the second information, and similarly, the second information may also be referred to as the first information. Depending on the context, the word “if” as used herein may be interpreted to mean “at . . . ” “when . . . ,” or, “in response to a determination.”

A vessel typically includes a hull, a propulsion system, and a control system. The propulsion system includes an outboard engine and a battery that powers the outboard engine. The control system includes a steering wheel, a telecontrol box and a remote controller. The outboard engine, as the name suggests, refers to the propulsion engine installed on the outside of the hull (vessel's rail), also known as outboard, and usually suspended on the outside of the stern plate. The outboard engine usually includes a propeller, a motor that drives the propeller to rotate, and a processor connected to the motor. With high integration and simple installation and purchase, the outboard engine may provide the power for personal leisure and entertainment vessels, and is also widely used in fisheries, commercial operations, and government law enforcement.

A topological graph of the vessel system can show the user what access devices are included in the vessel system and the connection relationship between the access devices. However, the topological graph of the vessel system usually needs to be manually generated by the user according to the composition of the vessel system, and the efficiency of generating the topological graph is low.

In this regard, the application proposes a method and a device for generating the topological graph of the vessel system, an outboard engine, a vessel and a storage medium, so as to solve the problem that the topological graph of the vessel system needs to be manually configured by the user.

The embodiment of the present application is described in detail in the following.

As shown in FIG. 1, FIG. 1 is a flow chart of a method for generating the topological graph of the vessel system illustrated according to an exemplary embodiment of the present application. The method includes the following steps:
step S101: obtaining device identification information sent by each of the access devices through the communication bus;
step S102: determining description information of a topological structure of the vessel system according to the device identification information;
step S103: sending the description information to a display device so that the display device converts the description information into a topological graph and displays the topological graph.

In the present application, the access devices in the vessel system include at least one of an outboard engine, a battery, a steering wheel, a telecontrol box, a remote controller and a display. The number of each type of access devices is greater than or equal to 1. The access devices can communicate with each other through a communication bus. The communication bus is used for connecting different access devices, and each access device can send information to the communication bus based on a preset communication protocol, and can also obtain information from the communication bus based on the communication protocol.

In some embodiments, the communication bus may be a Controller Area Network (CAN) bus. The CAN bus is a serial communication network that effectively supports distributed control or real-time control. When a node on the CAN bus transmits data, the CAN bus broadcasts the data sent by the node to all nodes in the network in the form of a message. For each node, the data is received whether or not it is addressed to itself.

In some embodiments, the communication bus may be an RS485 bus, and the nodes are connected in series by one bus, and the communication is realized by balanced transmission and differential reception. Of course, communication buses that can meet the communication characteristics in the above exemplary embodiments all fall within the scope of protection of the present application, and the present application is not limited herein.

In the present application, each access device has a unique device identification information. The topological structure of the vessel system can be confirmed according to the device identification information of each access device.

In some embodiments, the device identification information may include a device identification code, which may be used to identify the type of an access device or the identity of a particular access device, wherein the identity of access devices is used to distinguish multiple access devices of the same type. By pre-recording and saving the corresponding relationship between each access device and the encoding format of the access device and the specific numerical value of the access device, the type and identity of the access device can be determined by finding the correspondence. For example, when the device identification code meets the coding format of the outboard engine, the access device is the outboard engine; when the device identification code meets the coding format of the telecontrol box, the access device is the telecontrol box. For another example, the access devices include two outboard engines, which are respectively marked as an outboard engine I and an outboard engine II. When the device identification code is the same as the preset code of the outboard engine I, the access device is the outboard engine I; when the device identification code is the same as the preset code of the outboard engine II, the access device is the outboard engine II.

In some embodiments, the description information of the topological structure of the vessel system may be used to describe the type of the access devices and the connection relationship between the access devices and the communication bus. For example, after the types of all the access devices accessing the communication bus are identified according to the collected device identification information, the topological structure of the vessel system may be used to reflect the types of the access devices of the communication bus. For another example, after the specific identities of all the access devices accessing the communication bus are identified according to the collected device identification information, the topological structure of the vessel system may be used to reflect the specific identity of each access device accessing the communication bus. A user can set the specific content of the description information according to personal requirement.

In the present application, a plurality of outboard engines and a plurality of batteries are connected to ports provided by a power management module. Each outboard engine can be connected to an output port, and each battery can be connected to an input port. The correspondence between the output port and the input port is determined by a connection network built in the power management module, and an interface that can be connected or disconnected is set in the connection network. The power management module can determine which one or several outboard engines each battery supplies power to by controlling the on-off of the interface. The power management module is connected with the communication bus and can send an interface signal to the communication bus to be acquired by other devices, wherein the interface signal includes a switch-on signal and a switch-off signal. The connection relationship between the plurality of outboard engines and the plurality of batteries can be determined through the plurality of interface signals.

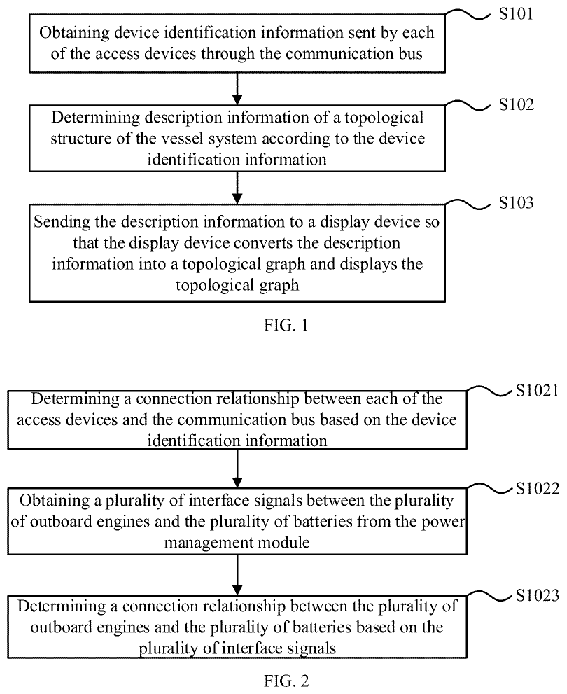

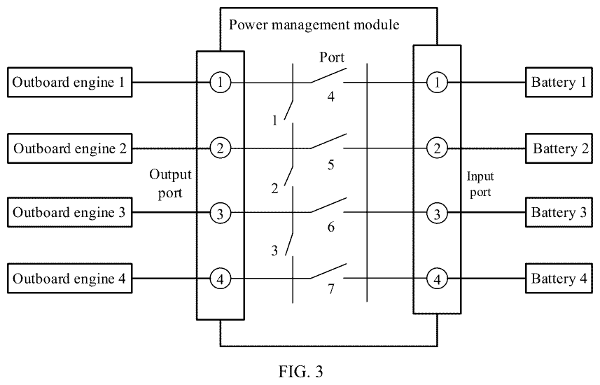

As shown in FIG. 2, FIG. 2 is a flow chart of another method for generating a topological graph of a vessel system according to an exemplary embodiment. This embodiment describes a processing procedure for determining the description information of the topological structure of the vessel system according to the device identification information on the basis of the foregoing embodiments, and the processing procedure includes the following steps:
step S1021: determining a connection relationship between each of the access devices and the communication bus based on the device identification information;
step S1022: obtaining a plurality of interface signals between the plurality of outboard engines and the plurality of batteries from the power management module; and
step S1023: determining a connection relationship between the plurality of outboard engines and the plurality of batteries based on the plurality of interface signals.

In some embodiments, as shown in FIG. 3, the description information may also be used to describe the connection relationship between a plurality of outboard engines and the plurality of batteries. For example, if each outboard engine has a matched battery, the description information may describe a single connection relationship between each outboard unit and each matched battery. For another example, each battery may correspondingly supply power to multiple outboard engines, and the description information may describe the connection relationship between each battery and the multiple outboard engines.

In the present application, the topological graph may be the description information being presented to the topological structure of the vessel system through the display device in a more user-friendly graphical interface.

In some embodiments, the description information may present the topological structure of the vessel system via the display device in the form of blocks and lines. For example, the blocks with different shapes may represent different types of access devices. For example, a circle represents a steering wheel, a rectangle represents an outboard engine, etc. The blocks of the same shape may distinguish different access devices of the same type by color. The connection relationship between the access devices and the communication bus may be represented by the connection of straight lines between the blocks. For another example, the blocks of different colors may represent different types of access devices, for example, green represents a steering wheel, blue represents an outboard engine, etc. The blocks of the same color may distinguish different access devices of the same type through text identification. The connection relationship between the access devices and the communication bus may be represented by the connection of curved lines between the blocks. For another example, the two-dimensional pattern corresponding to the access device may be used to represent the access device. For example, the pattern of the steering wheel is used to represent the steering wheel in the access devices, and the pattern of the battery is used to represent the battery in the access devices. In this way, the user can intuitively understand the specific access device included in the vessel system and the connection relationship between the access devices and the communication bus through the topological graph.

In some embodiments, the access device may be represented by a three-dimensional model. Different access devices correspond to different three-dimensional models. For example, each type of access device may be represented by a corresponding three-dimensional structure, and the same type of access device may be distinguished by different text identification. In a three-dimensional space, different access devices are connected with the communication bus through three-dimensional lines, which is equivalent to that the topological graph displayed by the display device is a three-dimensional stereogram, so that the user can intuitively understand the specific access devices included in the vessel system and the connection relationship between the access devices and the communication bus, and can also understand the three-dimensional structure of the access devices to deepen the understanding of the access devices.

In the present application, the vessel system may include a single outboard engine or a plurality of outboard engines. Each outboard engine is configured with a processor, and each outboard engine may obtain information sent by other access devices through the communication bus and process the information, and may also send information to other access devices. When the vessel system includes a plurality of outboard engines, the outboard engine serving as a master in the vessel system is responsible for acquiring the required data from other outboard engines, and performing operation processing according to the target task in combination with the data of the outboard engine and the data of the other outboard engines to obtain the result. The outboard engine serving as a slave needs to provide its own data to the master.

In some embodiments, the processors integrated into the outboard engine may be one or more electronic control units (ECU). The ECU is composed of a micro-controller (MCU), a memory (e.g., ROM, RAM, etc.), an input/output interface (I/O), an analog-to-digital converter (A/D) and a large-scale integrated circuit for shaping, driving, etc. The ECU has operation and control functions. Of course, a processor capable of completing the above functions belongs to the protection scope of the present application, and the present application is not limited herein.

In some embodiments, if the vessel system includes a single outboard engine, the outboard engine acquires the device identification information sent by each access device through the communication bus and performs subsequent processing of the device identification information.

In other embodiments, if the vessel system includes a plurality of outboard engines, the outboard engine serving as the master among the plurality of outboard engines may obtain the device identification information sent by each access device through the communication bus and perform subsequent processing on the device identification information.

In the application, after multiple outboard engines are accessed to the vessel system, one outboard engine can be selected as the master, and the other outboard engines are regarded as slave units through an election strategy.

In some embodiments, the election strategy may be to select the outboard engine which is firstly accessed to the communication bus as the master, which saves time in selecting the master.

In some embodiments, the election strategy may be to use the device identification codes in the device identification information. After all the outboard engines are accessed to the communication bus, each outboard engine can obtain the device identification codes of other outboard engines through the communication bus and compare the device identification codes with its own device identification code, and then it is determined that the outboard engine with the minimum device identification code is the master. In this way, under the condition that the communication is recovered after the power supply is cut off, the same outboard engine can still be selected as the master according to the election strategy, and the time-consuming behavior of data re-transmission or data re-acquisition caused by the replacement of the master can be avoided, the time of the user is prevented from being wasted, and the use experience of the user is prevented from being influenced.

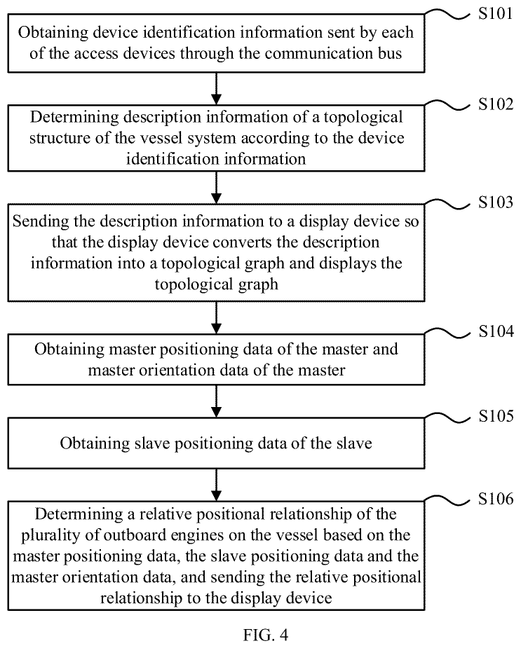

As shown in FIG. 4, FIG. 4 is a flow chart of another method for generating the topological graph of the vessel system according to an exemplary embodiment of the present application. On the basis of the foregoing embodiments, this embodiment further includes the following steps:
step S104, obtaining master positioning data of the master and master orientation data of the master;
step S105, obtaining slave positioning data of the slave; and
step S106: determining a relative positional relationship of the plurality of outboard engines on the vessel based on the master positioning data, the slave positioning data and the master orientation data, and sending the relative positional relationship to the display device.

In some embodiments, the master positioning data and the slave positioning data may be the longitude and latitude data corresponding to the host and the longitude and latitude data corresponding to the slave, respectively. The relative positional relationship between the master and the slave may be determined according to the longitude and latitude data corresponding to the master and the longitude and latitude data corresponding to the slave. For example, in the case of the same latitude, the longitude of the master is taken as the central reference value, and the relative positional relationship between the master and the slave can be determined by comparing the longitudes of the master and the slave. For example, if the master and the slave are located at different degrees of east longitude, the position of the slave relative to the master can be determined by comparing the degrees.

In the present application, the orientation of the outboard engine is generally aligned with the direction of the propulsive force, and the direction of the propulsive force is aligned with the direction of the vessel from the stern to the bow. For example, the outboard engine relies on the blades of the propeller to rotate in the water to convert the rotational power of the engine into propulsion force and drive the vessel, so the orientation of the outboard engine, the direction of the propulsion force, and the direction of the vessel from the stern to the bow should be consistent. Therefore, the orientation data of the master can be used to indicate the direction of the propulsion force of the outboard engine acting as the master, thereby indirectly obtaining the direction of the vessel from the stern to the bow.

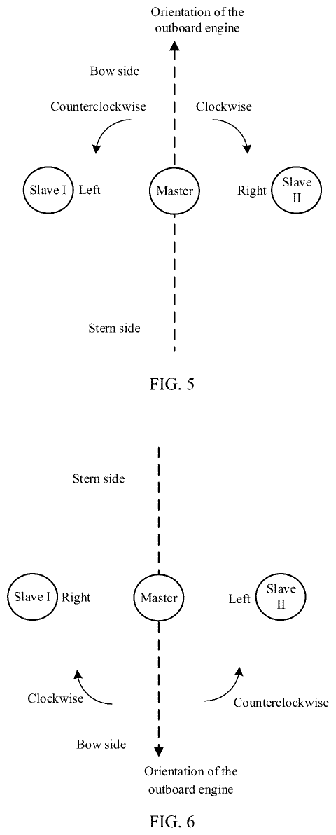

In some embodiments, the orientation of the master is taken as the positive central reference line, and at this time, the relative position of the slave with respect to the master in the left-right direction of the vessel under the orientation of the master can be determined on the basis of the positive central reference line and in combination with the position of the slave relative to the master obtained in the foregoing embodiments. Since the orientation of the master is consistent with the direction of the vessel from the stern to the bow, therefore, the relative position of the slave and the master in the left and right direction of the vessel can be obtained by taking the direction of the stern to the bow as a reference. For example, as shown in FIG. 5 and FIG. 6, the vessel system includes three outboard engines, wherein the orientation of the master is taken as the positive center reference line, and it can be determined from the position of the master that the slave I is located on the left side of the master, and the slave II is located on the right side of the master. Similarly, since the direction of the vessel from the stern to the bow is consistent with the orientation of the outboard engine, therefore, when the user stands on the stern of the vessel and looks at the bow, the slave I is located on the left side of the master, and the slave II is located on the right side of the master.

It should be noted that “left” and “right” herein are directions relative to the direction of the vessel from the stern to the bow. For example, taking the position of the maser as the center point and the direction of vessel from the stern to the bow as the reference direction, if the center point is regarded as the starting point of the vector and the direction of the vessel from the stern to the bow is regarded as the direction of the vector, the region rotated clockwise by 0 to 180 degrees from the starting point of the vector is determined as right, and the region rotated counterclockwise by 0 to 180 degrees from the starting point of the vector is determined as left.

In the application, the relative positional relationship can be combined with the topological graph of the vessel system to display a plurality of outboard engines, so that the user can correspondingly know the position distribution of the outboard engines on the vessel through the topological graph of the vessel system, and the operation related to the outboard engines, such as the maintenance and replacement of an outboard machine, is facilitated.

As shown in FIG. 7, FIG. 7 is a flow chart of another method for generating the topological graph of the vessel system according to an exemplary embodiment of the present application, describing a processing procedure for determining a relative positional relationship of the plurality of outboard engines on the vessel based on the master positioning data, the slave positioning data and the master orientation data. The processing procedure includes the following steps:
step S1061: determining the orientation of the master according to the acceleration data of the master;
step S1062: determining a stern-to-bow orientation of the vessel based on the orientation of the master; and
step S1063, determining the relative positional relationship of the plurality of outboard engines on the vessel according to the master positioning data, the slave positioning data and the stern-to-bow orientation of the vessel.

In some embodiments, the orientation data of the master may include acceleration data or angular velocity data of the master. Since the orientation of the master is consistent with the direction of the propulsion force, and the direction of the propulsion force of the master corresponds to the direction of the acceleration of the host, the acceleration data in orientation data of the master may be used to determine the orientation of the master, and thus the orientation of the vessel from the stern to the bow can be determined. For example, when the acceleration data shows that the acceleration value in the due north direction is a positive value, the orientation of the master at this time is due north. Since the direction of propulsion force of the master is parallel to the direction of the vessel from the stern to the bow, the current orientation of the vessel from the stern to the bow is due north.

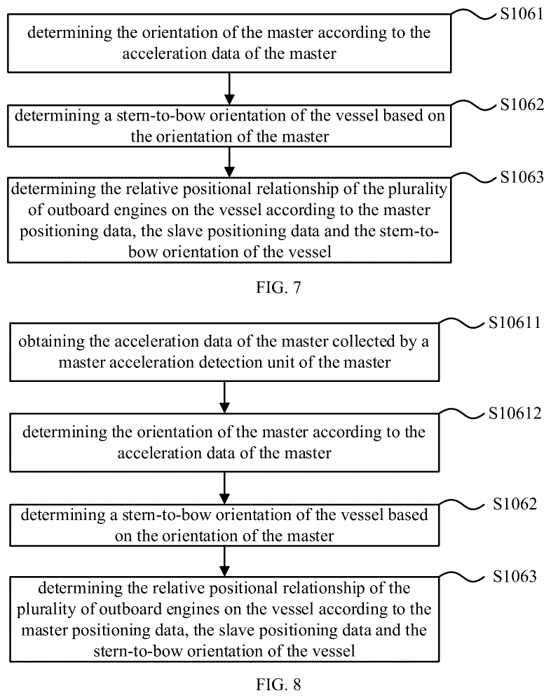

As shown in FIG. 8, FIG. 8 is a flow chart of another method for generating the topological graph of the vessel system according to an exemplary embodiment of the present application, which describes a processing procedure for determining the orientation of the master according to the acceleration data of the master. The processing procedure includes the following steps:
step S10611, obtaining the acceleration data of the master collected by a master acceleration detection unit of the master; and
step S10612: determining the orientation of the master according to the acceleration data of the master.

In some embodiments, the master acceleration detection unit may be an accelerometer.

In some embodiments, the master acceleration detection unit may be an inertial measurement unit (IMU). Of course, the devices capable of obtaining the above acceleration data fall within the scope of protection of the present application, which is not limited herein.

In some embodiments, the acceleration data of the master may be collected by the master acceleration detection unit built in the master, and then directly obtained by the processor of the master, so that the processor of the master does not need to perform additional communication to obtain data from other devices as the acceleration data of the master, which may improve the efficiency of the processor of the master in determining the orientation of the master.

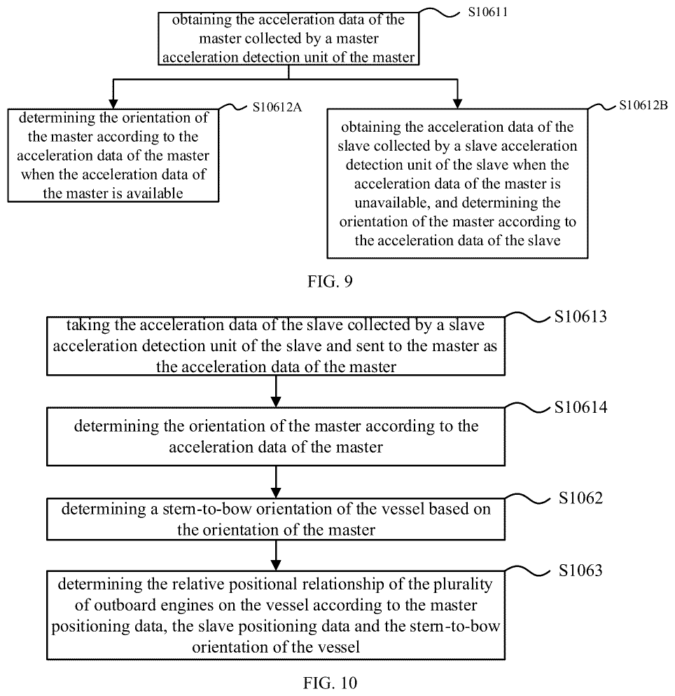

FIG. 9 is a flow chart of another method for generating the topological graph of the vessel system according to an exemplary embodiment. Based on the foregoing embodiments, this embodiment describes a processing procedure for determining the orientation of the master according to the acceleration data of the master. The processing procedure includes the following steps:
step S10612A: determining the orientation of the master according to the acceleration data of the master when the acceleration data of the master is available; and
step S10612B: obtaining the acceleration data of the slave collected by a slave acceleration detection unit of the slave when the acceleration data of the master is unavailable, and determining the orientation of the master according to the acceleration data of the slave.

In some embodiments, the slave acceleration detection unit may be an accelerometer.

In some embodiments, the slave acceleration detection unit may be an inertial measurement unit (IMU). Of course, the devices capable of obtaining the above acceleration data fall within the scope of protection of the present application, which is not limited herein.

In some embodiments, the processor of the master may determine whether the acceleration data of the master is available based on at least one of a data format, a value range of the acceleration data of the master, a communication status between the master acceleration detection unit and the processor of the master. For example, in the example of determining whether the acceleration data of the master is available according to the data format of the acceleration data of the master; the acceleration data of the master is considered to be available if the acceleration data of the master satisfies the preset data format; the acceleration data of the master is considered to be unavailable if the acceleration data of the master is garbled or intermittent. For another example, in the example of determining whether the acceleration data of the master is available based on the value range of the acceleration data of the master, the acceleration data of the master is considered to be available if the acceleration data of the master meets the preset value range, the acceleration data of the master is considered to be unavailable if the acceleration data of the master exceeds the upper or lower limit of the range. For another example, in the example of determining whether the acceleration data of the master is available according to the communication state between the master acceleration detection unit and the processor of the master, if the communication state between the master acceleration detection unit and the processor of the master is normal, the acceleration data of the master is regarded as available; if the communication state between the master acceleration detection unit and the processor of the master is abnormal, the acceleration data of the master cannot be obtained or the obtained acceleration data of the master is empty, and the acceleration data of the master is considered to be unavailable. When the acceleration data of the master is unavailable, the orientations of the master and the slave are usually consistent, the processor of the master can obtain the slave acceleration data collected by the slave acceleration detection unit as the substitute data, and determine the orientation of the master according to the slave acceleration data. In this way, it can be avoided that the orientation of the master cannot be determined when the acceleration data of the master is unavailable, thus affecting the display of the relative position of the outboard engines in the topological graph.

As shown in FIG. 10, FIG. 10 is a flow chart of another method for generating the topological graph of the vessel system according to an exemplary embodiment of the present application, and step S10611 and step S10612 may be replaced by step S10613 and step S10614.
Step S10613, taking the acceleration data of the slave collected by a slave acceleration detection unit of the slave and sent to the master as the acceleration data of the master; and
Step S10614: determining the orientation of the master according to the acceleration data of the master.

In some embodiments, considering that the user may have different requirements for the acceleration data acquisition rate or the range of the acceleration data, the acceleration detection units of the master and the slave are set differently. For example, the user sets the data acquisition rate of the master acceleration detection unit to be higher than that of the slave acceleration detection unit, and in the case of a lower acquisition rate requirement, the user may set the processor of the master to obtain the acceleration data of the slave from the acceleration detection unit of the slave as the acceleration data of the master (at this time, the acceleration detection unit of the master may not work to reduce energy consumption). For another example, the user sets the range interval of the acceleration data acquired by the master acceleration detection unit to be larger than that of the slave acceleration detection unit, and in the case where the requirement for the range interval of the acceleration data is not large, the user may set the processor of the master to acquire the slave acceleration data from the slave acceleration detection unit as the acceleration data of the master (at this time, the acceleration detection unit of the master may not work to reduce power consumption).

In some embodiments, the topological graph of the vessel system may be formed from the top view of the vessel, and the display direction of the topological graph from the bottom to the top may be the direction of the vessel from the stern to the bow. The topological graph may be based on displaying the plurality of outboard engines, the position distribution of the outboard engines on the vessel is further displayed according to the left and right position information of the slave relative to the master, so that the user can easily distinguish the position of the outboard engine according to the topological graph when the user is positioned on the vessel, and the user can conveniently distinguish the position of the outboard engines on the vessel, and to meet the control and detection requirements of the corresponding outboard engine.

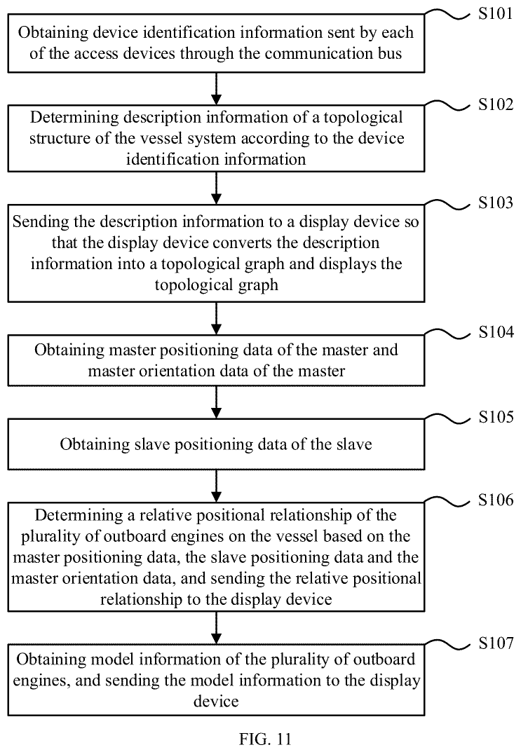

As shown in FIG. 11, FIG. 11 is a flow chart of another method for generating the topological graph of the vessel system according to an exemplary embodiment, this embodiment further includes the following steps on the basis of the foregoing embodiments:
step S107, obtaining model information of the plurality of outboard engines, and sending the model information to the display device.

In the present application, the model information of each outboard engine is unique.

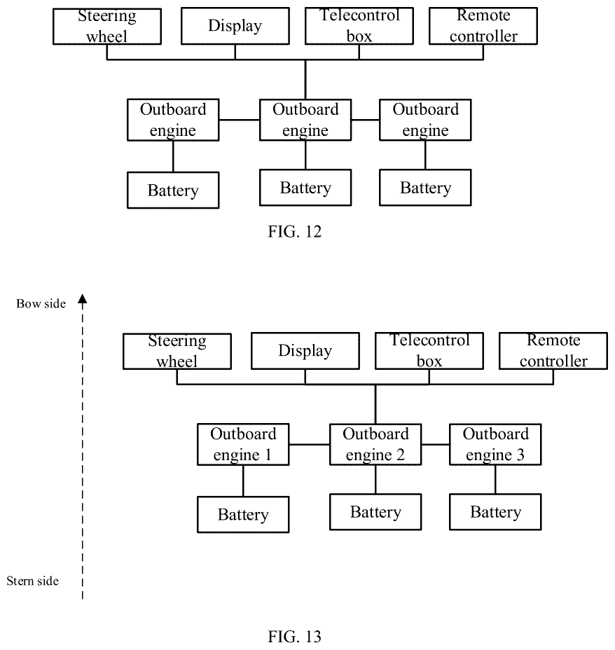

In some embodiments, the topological graph can correspondingly display the model of the outboard engine while displaying each outboard engine by using an icon, so that the user can match the outboard engine at the corresponding position on the actual vessel according to the model information at the corresponding position on the topological graph. For example, the vessel system includes three outboard engines of which the model numbers are 1, 2, and 3. The topological graph of the related art, as shown in FIG. 12, can only show the number of the outboard engines and cannot show the relative positions of the plurality of outboard engines. However, in this embodiment, as shown in FIG. 13, by obtaining the model information of the outboard engines, marking the outboard engines on the topological graph according to the model information of the outboard engines, and combining with the topological graph of the vessel system formed from the top view of the vessel in the foregoing embodiments, the topological graph can show the relative positions of the plurality of outboard engines on the vessel based on the direction from the stern to the bow of the vessel.

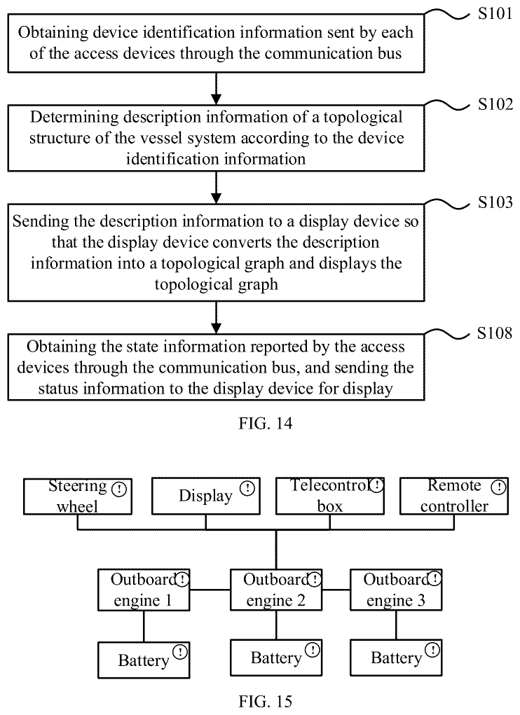

As shown in FIG. 14, which is a flow chart of another method for generating the topological graph of the vessel system according to an exemplary embodiment, this embodiment further includes the following steps on the basis of the foregoing embodiments:
step S108: obtaining the state information reported by the access devices through the communication bus, and sending the status information to the display device for display.

In some embodiments, the state information may include at least one of a remaining charge of the access devices, an accumulated usage time, a real-time temperature, and whether a function of the access devices is available. For example, when the access device is an outboard engine, the state information may include the accumulated service time, the real-time temperature, and whether the function of the outboard engine is available, wherein the accumulated service time may tell the user the accumulated working time of the outboard engine, so that the user can perform regular maintenance or replacement on the outboard engine in combination with the average life of the outboard engine; the real-time temperature can tell the user the operating temperature value of the outboard engine, and adjust the operation of the outboard engine in combination with the temperature range of normal use; whether the function is available can tell the user whether the outboard engine is in a normal state. For another example, when the access device is a wireless telecontrol box, the state information may include the remaining charge of the wireless telecontrol box and whether the function of the wireless telecontrol box is available, wherein the remaining charge may tell the user the consumption degree of the pre-stored charge of the wireless telecontrol box, so that the user can conveniently judge whether the charging is needed; whether the function of the wireless telecontrol box is available may tell the user whether the wireless telecontrol box is in a normally working state.

In some embodiments, the state information and the topological graph may be displayed on the display device simultaneously. For example, the state information of each access device may be correspondingly displayed near the area representing the access device in the topological graph. For another example, the state information of each access device may be correspondingly displayed in the area representing the access device in the topological graph.

In some embodiments, a function entrance for triggering the display of the state information of the access device may be set in the display area of the topological graph corresponding to different access devices. For example, as shown in FIG. 15, a small icon may be set in the display area of an access device, and when the user triggers the small icon, the state information may be displayed in the form of a pop-up window. For another example, after the user triggers the display area of an access device, the state information may be displayed in the corresponding display area. The carrier of the user triggering action includes a keyboard, a mobile phone touch screen or a mouse.

In some embodiments, the display device may be a display of the vessel system, and the description information may be sent to the display via communication bus of the vessel system, and the topological graph is displayed on the display.

In some embodiments, the display device may be a user terminal. The outboard engine may further integrate a wireless communication module. The description information may be uploaded to a cloud server through the wireless communication module, and then the cloud server may forward the description information to the user terminal, and the topological graph is displayed on the user terminal. For example, if the user terminal is a mobile phone, the topological graph can be displayed through a mobile phone application. For another example, if the user terminal is a computer, the topological graph can be displayed through a computer web page.

In the present application, the access devices of the vessel system may be changed. The user may add or remove the access devices according to his own needs, so that the topological graph of the vessel system may need to be updated.

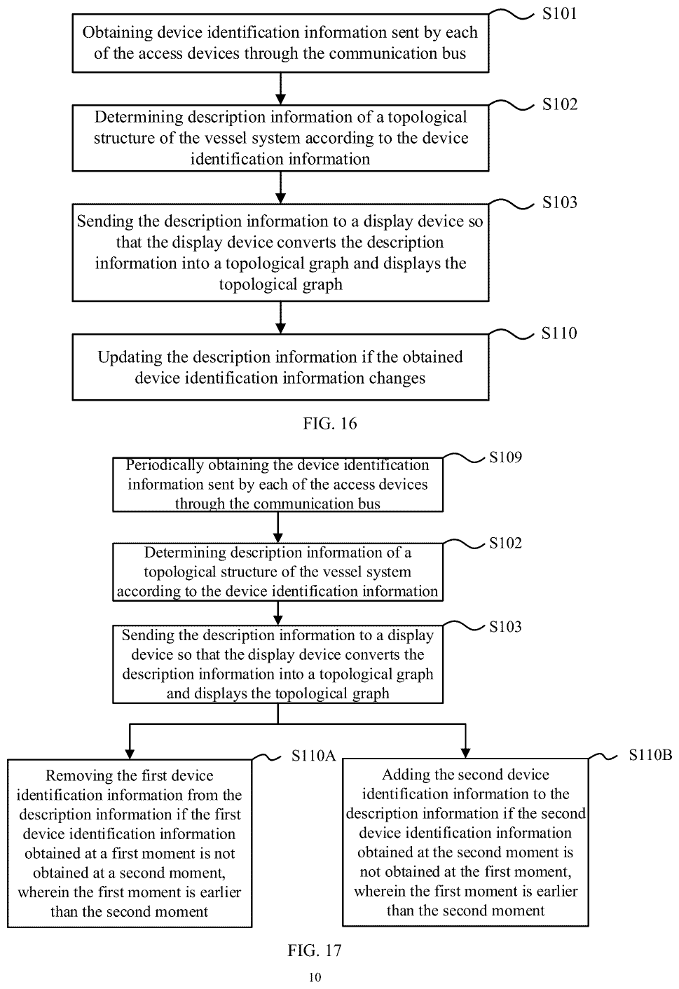

As shown in FIG. 16, FIG. 16 is a flow chart of another method for generating the topological graph of the ship vessel according to an exemplary embodiment. Step S101 may be replaced with step S109 in this embodiment on the basis of the foregoing embodiments.

Step S109: periodically obtaining the device identification information sent by each of the access devices through the communication bus.

The method further includes the step of:
step S110, updating the description information if the obtained device identification information changes.

In some embodiments, a single outboard engine or a master of multiple outboard engines may set a fixed time interval to periodically update the acquired device identification information. For example, it is set that the device identification information of each access device is re-obtained every 5 seconds.

As shown in FIG. 17, FIG. 17 is a flow chart of another method for generating the topological graph of the ship system according to an exemplary embodiment. On the basis of the foregoing embodiments, this embodiment describes a processing procedure for updating the description information if the obtained device identification information changes. The processing procedure includes the following steps:
step S110A: removing the first device identification information from the description information if the first device identification information obtained at a first moment is not obtained at a second moment, wherein the first moment is earlier than the second moment; and
step S110B, adding the second device identification information to the description information if the second device identification information obtained at the second moment is not obtained at the first moment, wherein the first moment is earlier than the second moment.

In some embodiments, after obtaining the device identification information of a access device, if the single outboard engine or the master of multiple outboard engines is unable to continue to obtain the device identification information of the access device through the communication bus in one or more consecutive cycles, the device identification information is removed automatically on the basis of the original description information, and the display of the access device will be removed or disabled accordingly in the topological graph.

In some embodiments, if the device identification information of a access device obtained by the single outboard engine or the master of multiple outboard engines at a moment is a device identification information that has not been obtained at a previous moment, the device identification information is automatically added to the existing description information, and the display of the access device is correspondingly added to the topological graph.

In addition, the present application further provides an apparatus for generating the topological graph of the vessel system.

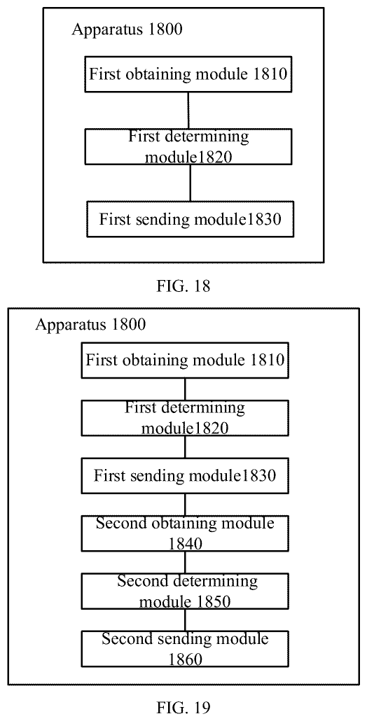

As shown in FIG. 18, FIG. 18 is a schematic diagram of an apparatus 1800 for generating the topological graph of the ship vessel according to an exemplary embodiment of the present application, wherein a plurality of access devices of the vessel system communicate through a communication bus of the vessel system. The apparatus 1800 includes:
a first obtaining module 1810 which is configured to obtain device identification information sent by each of the access devices through the communication bus;
a first determining module 1820 which is configured to determine description information of a topological structure of the vessel system according to the device identification information; and
a first sending module 1830 which is configured to send the description information to a display device so that the display device converts the description information into a topological graph and displays the topological graph.

In some embodiments, the access device includes at least one of an outboard engine, a battery, a steering wheel, a telecontrol box, a remote controller, and a display.

In some embodiments, the access devices comprise a plurality of outboard engines and a plurality of batteries, and a power management module is connected between the plurality of outboard engines and the plurality of batteries. The first determining module 1820 is specifically configured to determine a connection relationship between each of the access devices and the communication bus based on the device identification information, obtain a plurality of interface signals between the plurality of outboard engines and the plurality of batteries from the power management module, and determining a connection relationship between the plurality of outboard engines and the plurality of batteries based on the plurality of interface signals.

In some embodiments, the access devices include outboard engines. When the number of the outboard engines is greater than 1, the step of obtaining device identification information sent by each of the access devices through the communication bus is executed by the outboard engine acting as a master among the plurality of outboard engines.

As shown in FIG. 19, FIG. 19 is a schematic structural diagram of another apparatus 1800 for generating the topological graph of the vessel system according to an exemplary embodiment. On the basis of the foregoing embodiments, the apparatus 1800 of this embodiment further includes: a second obtaining module 1840 configured to obtain master positioning data of the master and master orientation data of the master and obtain slave positioning data of the slave; a second determining module 1850 configured to determine a relative positional relationship of the plurality of outboard engines on the vessel based on the master positioning data, the slave positioning data and the master orientation data; a second sending module 1860 configured to send the relative positional relationship to the display device.

In some embodiments, the master is an outboard engine which is firstly accessed to the communication bus; or, the device identification information of the outboard engine includes a device identification code, and the master is the outboard engine with a minimum device identification code among the plurality of outboard engines.

In some embodiments, the master orientation data includes acceleration data of the master, and the second determining module 1850 is further configured to determine the orientation of the master according to the acceleration data of the master, determine a stern-to-bow orientation of the vessel based on the orientation of the master, and determine the relative positional relationship of the plurality of outboard engines on the vessel according to the master positioning data, the slave positioning data and the stern-to-bow orientation of the vessel.

In some embodiments, the second determining module 1850 is further configured to obtain the acceleration data of the master collected by a master acceleration detection unit of the master, and determine the orientation of the master according to the acceleration data of the master.

In some embodiments, the second determining module 1850 is further configured to determine the orientation of the master according to the acceleration data of the master when the acceleration data of the master is available, obtain the acceleration data of the slave collected by a slave acceleration detection unit of the slave when the acceleration data of the master is unavailable, and determine the orientation of the master according to the acceleration data of the slave.

In some embodiments, the second determination module 1850 is further configured to take the acceleration data of the slave collected by a slave acceleration detection unit of the slave and sent to the master as the acceleration data of the master, and determining the orientation of the master according to the acceleration data of the master.

In some embodiments, the topological graph of the vessel system is used for representing the connection relationship of each of the access devices in the vessel system and the relative positions of the plurality of outboard engines on the vessel under the top view of the vessel.

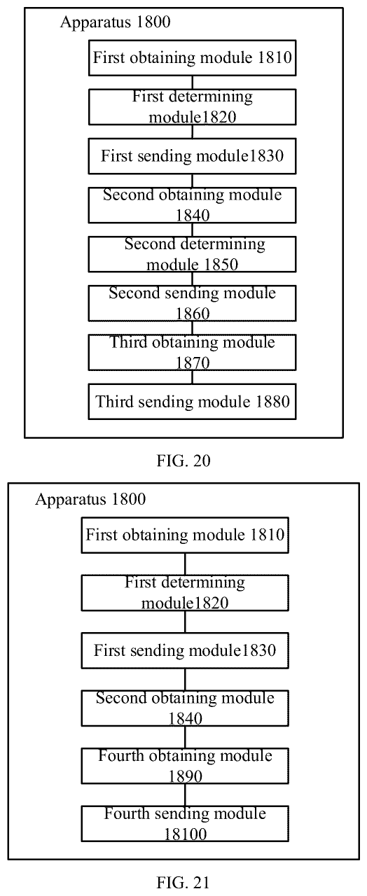

As shown in FIG. 20, FIG. 20 is a schematic structural diagram of another apparatus 1800 for generating the topological graph of the vessel system according to an exemplary embodiment. On the basis of the foregoing embodiments, the apparatus 1800 of this embodiment further includes the following modules: a third obtaining module 1870 configured to obtain model information of the plurality of outboard engines; a third sending module 1880 configured to send the model information to the display device.

In some embodiments, the topological graph of the vessel system is further used for displaying the models of the plurality of outboard engines.

As shown in FIG. 21, FIG. 21 is a schematic structural diagram of another apparatus 1800 for generating the topological graph of the vessel system according to an exemplary embodiment. On the basis of the foregoing embodiments, the apparatus 1800 of this embodiment further includes: a fourth obtaining module 1890 configured to obtain the state information reported by the access devices through the communication bus; a fourth sending module 18100 configured to send the status information to the display device for display.

In some embodiments, the state information and the topological graph are displayed on the display device simultaneously; or, the display device includes a function entrance, and the state information is displayed on the display device after the function entrance is selected.

In some embodiments, the display device is a display of the vessel system, and the first sending module 1830 is further configured to send the description information to the display of the vessel system through the communication bus.

In some embodiments, the display device is a user terminal, and the first sending module 1830 is further configured to upload the description information to a cloud server through a wireless communication module so that the cloud server forwards the description information to a user terminal.

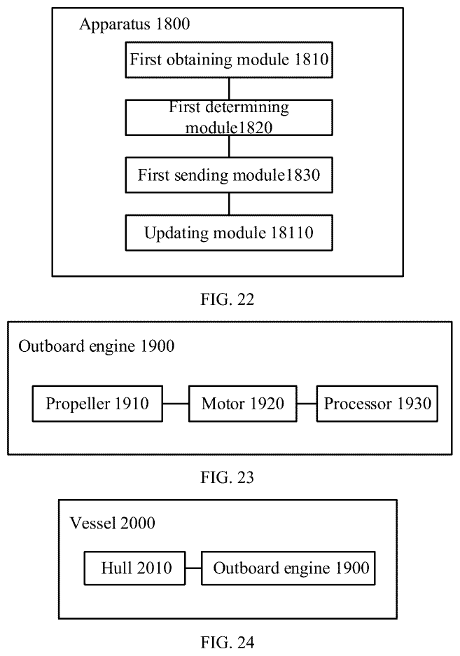

In some embodiments, the first obtaining module 1810 is further configured to periodically obtain the device identification information sent by each of the access devices through the communication bus. As shown in FIG. 22, the aforementioned apparatus 1800 further includes a first updating module 18110 configured to update the description information if the obtained device identification information changes.

In some embodiments, the first updating module 18110 is further configured to remove the first device identification information from the description information if the first device identification information obtained at a first moment is not obtained at a second moment, wherein the first moment is earlier than the second moment; or, the first updating module 18110 is further configured to add the second device identification information to the description information if the second device identification information obtained at the second moment is not obtained at the first moment, wherein the first moment is earlier than the second moment.

In addition, the present application also provides an outboard engine. As shown in FIG. 23, the outboard engine 1900 includes a propeller 1910, a motor 1920 for driving the propeller 1910 to rotate, and a processor 1930 connected to the motor 1920. The implementation process of the functions and effects of the processor 1930 is detailed in the implementation process of the corresponding steps in the above method, and will not be described here.

In addition, the present application provides a vessel. As shown in FIG. 24, a vessel 2000 according to an exemplary embodiment of the present application includes a hull 2010, and the hull 2010 is loaded with an outboard engine 1900 described in the above embodiments of the present application. The implementation process of the functions and effects of the processor 1930 in the outboard engine 1900 is detailed in the implementation process of the corresponding steps in the above method, which will not be described here.

In addition, the present application also provides a computer readable storage medium, on which a computer program is stored. The computer program is executed by a processor to implement the method described in any of the preceding embodiments.

The computer readable storage medium, includes both permanent and non-permanent, removable and non-removable media, and may be implemented in any method or technology for information storage. Information may be computer readable instructions, data structures, modules of programs, or other data. Examples of The computer readable storage medium include, but are not limited to, phase change memory (RAM), static random access memory (SRAM), dynamic random access memory (DRAM), other types of random access memory (RAM), read only memory (ROM), electrically erasable programmable read only memory (EEPROM), flash memory or other memory technologies, compact disc read-only memory (CD-ROM), digital versatile disks (DVD) or other optical storage, magnetic cassettes, magnetic tape, magnetic disk storage or other magnetic storage devices, or any other non-transmission medium that can be used to store information that can be accessed by a computing device. As defined herein, the computer readable media does not include transitory media, such as modulated data signals and carrier waves.

For the embodiments of the apparatus, since it basically corresponds to the embodiments of the method, it is sufficient to refer to the description of the embodiments of the method. The embodiments of the apparatus described above are merely illustrative, wherein the modules illustrated as separate components may or may not be physically separated, and the components shown as modules may or may not be physical modules, i.e., may be located in one place, or may be distributed over a plurality of network modules. Some or all of the modules may be selected according to actual needs to achieve the purpose of the solution of the present application. Those of ordinary skill in the art can understand and implement it without creative effort.

The foregoing describes specific embodiment of that present application. Other embodiments are within the scope of the appended claims. In some cases, the acts or steps recited in the claims may be performed in a different order than in the embodiments and still achieve desirable results. In addition. The processes depicted in the figures do not necessarily require the particular order shown or the sequential order to achieve desirable results. Multitasking and parallel processing are also possible or may be advantageous in some embodiments.

Other embodiments of the present application will easily occur to those skilled in the art upon consideration of the specification and practice of the invention claimed herein. This application is intended to cover any variations, uses, or adaptations of the present application, that follow the general principles of the present application and include common general knowledge or customary technical means in the art not claimed in this application. It is intended that the specification and examples be considered as exemplary only, with a true scope and spirit of the application being indicated by the appended claims.

It is to be understood that this application is not limited to the precise constructions which have been described above and illustrated in the accompanying drawings, and that various modifications and changes may be made without departing from the scope thereof. The scope of the present application is limited only by the appended claims.

The above description is only a preferred embodiment of the present application, and is not intended to limit the present application. Any modification, equivalent substitution, improvement, etc., made within the spirit and principle of the present application shall be included in the scope of protection of the present application.

What is claimed is:

1. A method for generating a topological graph of a vessel system, wherein a plurality of access devices of the vessel system are configured to communicate through a communication bus of the vessel system, and the method comprises:
obtaining device identification information sent by each of the access devices through the communication bus;
determining description information of a topological structure of the vessel system according to the device identification information, the description information being used to characterize a connection relationship between each of the access devices and the communication bus; and
sending the description information to a display device so that the display device converts the description information into the topological graph and displays the topological graph.

2. The method of claim 1, wherein the access devices comprise at least one of the following: an outboard engine, a battery, a steering wheel, a telecontrol box, a remote controller, or a display.

3. The method of claim 1, wherein the access devices comprise a plurality of outboard engines and a plurality of batteries, and a power management module is connected between the plurality of outboard engines and the plurality of batteries, and
wherein determining description information of a topological structure of the vessel system according to the device identification information comprises:
determining a connection relationship between each of the access devices and the communication bus based on the device identification information;
obtaining a plurality of interface signals between the plurality of outboard engines and the plurality of batteries from the power management module; and
determining a connection relationship between the plurality of outboard engines and the plurality of batteries based on the plurality of interface signals.

4. The method of claim 1, wherein the access devices comprise outboard engines, and
wherein, when the number of the outboard engines is greater than 1, the obtaining device identification information sent by each of the access devices through the communication bus is executed by a master outboard engine among the plurality of outboard engines.

5. The method of claim 1, wherein the access devices comprise a plurality of outboard engines, and the plurality of outboard engines comprise a master outboard engine and at least one slave outboard engine, and
wherein the method further comprises:
obtaining master positioning data of the master outboard engine and master orientation data of the master outboard engine;
obtaining slave positioning data of the slave outboard engine;
determining a relative positional relationship of the plurality of outboard engines on a vessel based on the master positioning data, the slave positioning data and the master orientation data; and
sending the relative positional relationship to the display device, wherein the relative positional relationship is configured to display the plurality of outboard engines in the topological graph of the vessel system, and the relative positions among the plurality of outboard engines displayed in the topological graph are the same as the relative positions of the plurality of outboard engines on the vessel.

6. The method of claim 4, wherein
the master outboard engine is an outboard engine which is firstly accessed to the communication bus;
or,
the device identification information of the outboard engine comprises a device identification code, and the master outboard engine is the outboard engine with a minimum device identification code among the plurality of outboard engines.

7. The method of claim 5, wherein the master orientation data comprises acceleration data of the master outboard engine, and the determining a relative positional relationship of the plurality of outboard engines on the vessel based on the master positioning data, the slave positioning data and the master orientation data comprises:
determining the orientation of the master outboard engine according to the acceleration data of the master outboard engine;
determining a stern-to-bow orientation of the vessel based on the orientation of the master outboard engine; and
determining the relative positional relationship of the plurality of outboard engines on the vessel according to the master positioning data, the slave positioning data and the stern-to-bow orientation of the vessel.

8. The method of claim 7, wherein determining the orientation of the master outboard engine according to the acceleration data of the master outboard engine comprises:
obtaining the acceleration data of the master outboard engine collected by a master acceleration detection unit of the master outboard engine, and determining the orientation of the master outboard engine according to the acceleration data of the master outboard engine.

9. The method of claim 8, wherein determining the orientation of the master outboard engine according to the acceleration data of the master outboard engine comprises:
determining the orientation of the master outboard engine according to the acceleration data of the master outboard engine when the acceleration data of the master outboard engine is available; or
obtaining the acceleration data of the slave outboard engine collected by a slave acceleration detection unit of the slave outboard engine when the acceleration data of the master outboard engine is unavailable, and determining the orientation of the master outboard engine according to the acceleration data of the slave outboard engine.

10. The method of claim 7, wherein the determining the orientation of the master outboard engine according to the acceleration data of the master outboard engine comprises:
obtaining the acceleration data of the slave outboard engine collected by a slave acceleration detection unit of the slave outboard engine and sent to the master outboard engine as the acceleration data of the master outboard engine, and determining the orientation of the master outboard engine according to the acceleration data of the master outboard engine.

11. The method of claim 5, wherein the topological graph of the vessel system is configured to represent the connection relationship of each of the access devices in the vessel system and the relative positions of the plurality of outboard engines on the vessel under a top view of the vessel.

12. The method of claim 5, further comprising:
obtaining model information of the plurality of outboard engines, and sending the model information to the display device, wherein the model information is configured to display models of the plurality of outboard engines in the topological graph of the vessel system.

13. The method of claim 12, wherein the topological graph of the vessel system is further configured to display the models of the plurality of outboard engines.

14. The method of claim 1, further comprising:
obtaining state information reported by the access devices through the communication bus, and sending the state information to the display device for display.

15. The method of claim 14, wherein
the state information and the topological graph are displayed on the display device simultaneously;
or,
the display device comprises a function entrance, and the state information is displayed on the display device after the function entrance is selected.

16. The method of claim 1, wherein the display device is a display of the vessel system, and the sending the description information to a display device comprises:
sending the description information to the display of the vessel system through the communication bus;
or,
the display device is a user terminal, and the sending the description information to a display device comprises:
uploading the description information to a cloud server through a wireless communication module so that the cloud server forwards the description information to the user terminal.

17. The method of claim 1, wherein obtaining device identification information sent by each of the access devices through the communication bus comprises:
periodically obtaining the device identification information sent by each of the access devices through the communication bus; and
wherein the method further comprises:
updating the description information when the obtained device identification information changes.

18. The method of claim 17, wherein
updating the description information when the obtained device identification information changes comprises:
removing first device identification information from the description information when the first device identification information obtained at a first moment is not obtained at a second moment, wherein the first moment is earlier than the second moment;
or,
adding second device identification information to the description information when the second device identification information obtained at the second moment is not obtained at the first moment, wherein the first moment is earlier than the second moment.

19. An outboard engine, comprising:
a propeller;
a motor configured to drive the propeller to rotate; and
a processor connected to the motor, the processor being configured to execute the method for generating a topological graph of a vessel system according to claim 1.

20. A vessel, comprising:
a hull; and
an outboard engine mounted to the hull,
wherein the outboard engine comprises:
a propeller;
a motor configured to drive the propeller to rotate; and
a processor connected to the motor, the processor being configured to execute the method for generating a topological graph of a vessel system according to claim 1.
